(19) United States
(12) Patent Application Publication
(10) Pub. No.: US 2010/0170347 A1
(43) Pub. Date: Jul. 8, 2010

(54) METHOD AND APPARATUS FOR CONTINUOUS MACHINERY ALIGNMENT MEASUREMENT

(75) Inventor: Wesley D. Franklin, Minden, NV (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/350,116

(22) Filed: Jan. 7, 2009

(51) Int. Cl. G01N 3/00

(52) U.S. Cl. 73/794

(57) ABSTRACT

Systems and methods are provided for continuously determining the alignment of one or more machines. A method includes measuring one or more stresses on a first component of a first machine coupled to a second machine during operation of the first machine, wherein the first machine is coupled to the second machine, and determining alignment of the first machine based on stress measurements of the first machine.

### BACKGROUND OF THE INVENTION

The subject matter disclosed herein relates to machines and, more specifically, to alignment of machines during operation.

Various systems, such as manufacturing systems, power systems, etc., use machines to perform a variety of tasks. In many systems, two or more machines are operated together, such that stationary or rotating components of the machines are in a specific alignment. The alignment of these components ensures proper operation of the machines, reduces wear, and reduces the possibility of damage that could result in downtime of the machines. The alignment of the machines is typically performed during assembly and installation of the machines, and the conventional alignment techniques include laser systems and optical methods. These methods are generally not suitable for long term continuous monitoring.

During operation of such machines, misalignment may occur as a result of a number of factors. For example, misalignment can gradually occur after the initial alignment because of foundation settling, temperature changes, etc. The stresses caused by the misalignment can cause damage and wear to the machines. The stresses are not typically monitored during operation of the machines, thereby resulting in undetected damage and wear.

### BRIEF DESCRIPTION OF THE INVENTION

In one embodiment, a computer-implemented method includes measuring one or more stresses on a first component of a first machine coupled to a second machine during operation of the first machine, wherein the first machine is coupled to the second machine, and determining alignment of the first machine based on the stress measurements of the first machine.

In another embodiment, a system includes a first machine, a second machine coupled to the first machine, a first plurality of transducers configured to measure stresses on a first component of the first machine, and a monitor configured to receive signals from the first plurality of transducers. The monitor includes logic configured to determine alignment of the first machine based on the measured stresses on the first component of the first machine.

In another embodiment, a tangible machine-readable medium includes code stored on the tangible machine-readable medium, the code having instructions for determining one or more stresses on a component of a first machine coupled to a second machine, during operation of the first machine, wherein the first machine is coupled to the second machine and determining alignment of the first machine based on the one or more stresses of the first machine.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of a system having a machine monitor in accordance with an embodiment of the present invention;

FIGS. 2A-2C are diagrams that depict different types of misalignments of the machines of the system of FIG. 1 in accordance with an embodiment of the present invention;

FIG. 3 is a diagram that depicts the determination of stresses on a component of a machine in accordance with an embodiment of the present invention;

FIG. 4 is a diagram that depicts the determination of the displacement and angle of a misalignment for a uniform beam of a component of a machine in accordance with an embodiment of the present invention; and

FIG. 5 is a block diagram of a process for determining possible misalignments of a machine in accordance with an embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present invention include a system and method for continuously determining misalignments during the operation (e.g., in real-time) of one or more machines. A machine may have one or more components aligned with another machine. Stresses on the component may be determined by finding the major axis of the stress and measuring the maximum and minimum stresses on that axis. The misalignment of the machine may be determined from the stresses. Additionally, axial misalignment and bending stress may be determined from the maximum and minimum stresses. Further, angular misalignment and offset misalignment may be determined from the bending stress.

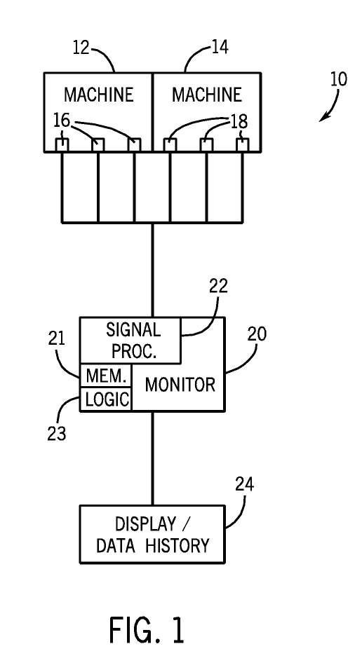

FIG. 1 illustrates a system 10 having machines 12 and 14 (or first and second sections of a single machine) in accordance with an embodiment of the present invention. As discussed below, the system may be configured to monitor parameters and detect misalignments during operation of the machines 12 and 14 based at least in part on a determination of a major axis of stress, a minimum stress on the axis, and a maximum stress on the axis. The system 10 includes a plurality of transducers 16 and 18 coupled to the machines 12 and 14 to monitor various parameters. For example, transducers 16 may monitor machine 12, and transducers 18 may monitor machine 14. A monitor 20, having signal processing circuitry 22, may receive signals from the transducers 16 and 18 and provide the processed signal to a display and data historian 24.

The transducers 16 and 18 may monitor any parameter, such as temperature, speed, vibration, noise, pressure, and so forth. As described further below, the transducers 16 and 18 may also monitor stresses on various components of the machines 12 and 14. The monitor 20 may include a printed circuit (PC) board or other electronic module capable of performing the signal processing on the signals received from the transducers 16 and 18. The signal processing circuitry 22 may condition the signals from the transducers 16 and 18 and convert the signals to any format, such as converting from analog to digital signals. The display and data historian 24 can receive the converted signals from the monitor 20 and display textual or graphical information about the machines 12 and 14. The monitor 20 may include memory 21, such as any suitable type of non-volatile memory, volatile memory, or combination thereof. The memory 21 may include logic 23 for performing the stress and alignment/misalignment determinations discussed herein. The logic 23 may be implemented in hardware, software (such as code stored on a tangible machine-readable medium) or a combination thereof.

The machine 12 may include one or more components that interface with or couple to the machine 14. Similarly, the machine 14 may include one or more components that interface with or couple to the component of the machine 12. In some embodiments, the machines 12 and 14 may be different portions of a single machine. These components may include rotors, shafts, any rotating component, any translating component, and any non-moving component. To ensure proper operation of the machines 12 and 14, the components of the machine 12 may be aligned with the machine 14 and vice-versa. The machines 12 and 14 may be aligned during installation, such as by moving the machines 12 and 14 until the respective components are aligned. During operation of the system 10, the machines 12 and 14 may be become misaligned as a result of temperature changes, foundation shifts, and other factors.

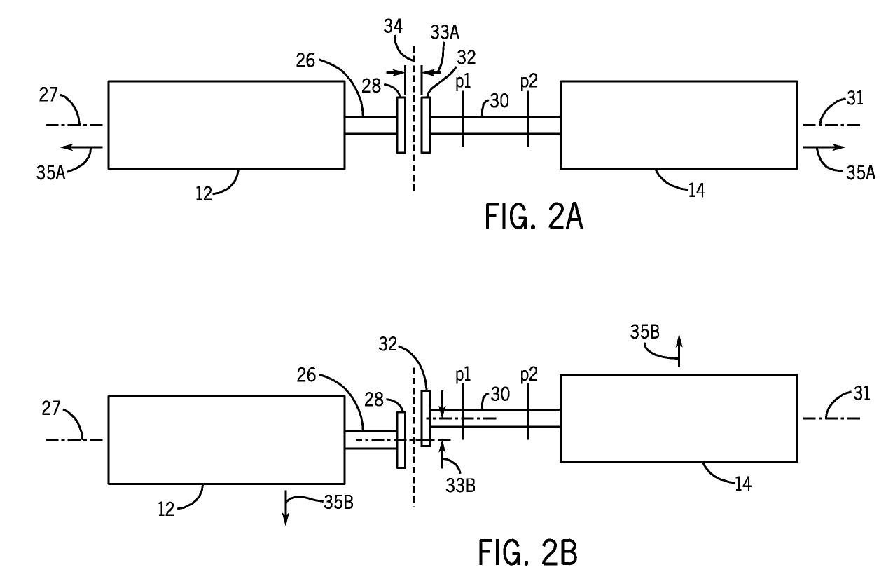

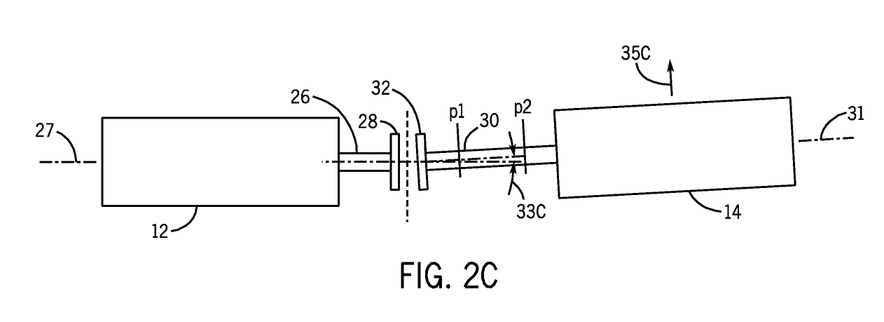

FIGS. 2A-2C illustrate various misalignments that may occur between the machines 12 and 14. As shown in FIGS. 2A-2C, the machine 12 may include a shaft 26 and a coupling 28. Similarly, the machine 14 may include a shaft 30 and a coupling 32. During operation of the machine, either shaft 26 or 30 may rotate and cause rotation of the other shaft through the couplings 28 and 32. It should be appreciated that the rotational shafts 26 and 30 are merely examples of components of the machines 12 and 14 used to illustrate misalignments, and that the machines 12 and 14 may include any other nonmoving, rotating, and/or translatable components that be used with the techniques described herein. Misalignments of the machines 12 and 14 may be defined relative to an axis 27 of the machine 12 and/or and axis 31 of the machine 14. Misalignments may also be defined relative to an axis 34 defined as the axis of the union of the couplings 28 and 32. In some embodiments, the shaft 26 may be a shaft of a rotor of the machine 12, such that the axis 27 is the axis of the rotor. Similarly, in some embodiments the shaft 30 may be a shaft of a rotor of the machine 14, such that the axis 31 is the axis of the rotor.

FIG. 2A illustrates axial misalignment (e.g., offset 33A) between the machines 12 and 14. As a result of axial misalignment, the shaft 26 and coupling 28 of the machine 12 may not be in complete contact or engagement with the shaft 30 and coupling 32 of the machine 14. Such a misalignment results if the machine 12 and/or the machine 14 move perpendicularly away from the axis 34, as indicated by arrows 35A along axes 27 and 31 (e.g., offset 33A).

FIG. 2B illustrates an offset misalignment between the machines 12 and 14. In an offset misalignment, the shaft 30 and coupling 32 of the machine 14 is offset from the shaft 26 and coupling 28 of the machine 12, such that the couplings 32 and 28 are offset parallel to the axis 27. An offset misalignment may occur if the machine 14 and/or the machine 12 moves parallel along the axis 34, as indicated by arrows 35B, and is offset from the axis 27. In other words, the offset 33B may result in an offset parallel arrangement of the axes 27 and 31.

FIG. 2C illustrates an angular misalignment (e.g., angle 33C) between the machines 12 and 14. In an angular misalignment, the shaft 30 and coupling 32 of the machine 14 aligned at a different angle, relative to the axis 27, than the shaft 26 and coupling 28 of the machine 12. Such an angular misalignment may occur if the machine 14 moves at a non-perpendicular or non-parallel angle relative to the axis 27, as indicated by arrow 35C. In other words, the angle 33C is a non-zero angle between axes 27 and 31.

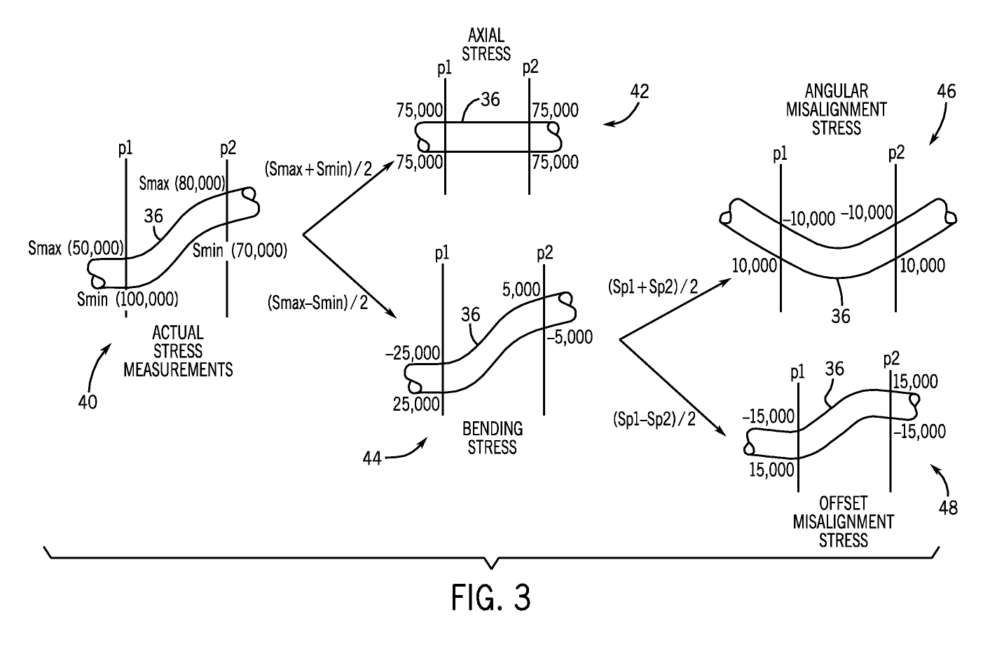

FIG. 3 is a diagram that illustrates the determination of various stresses that may be correlated with the misalignments described above, in accordance with an embodiment of the present invention. These stresses are therefore indicative of the alignment of a machine, such as machine 12 or 14. As shown in FIG. 3, an axis 36 of a component of a machine 12 or 14, such as axes 27 or 31, may exhibit stresses as a result of the various misalignments discussed above. The various sequences depicted in FIG. 3 illustrate derivation of different stresses and misalignments from the actual stresses. In this manner, the measured stresses may be used to determine the alignment of a machine having the component being monitored.

The stresses may be measured at two points p1 and p2 of the axis 36, such as by the transducers 16 and 18. The points p1 and p2 may correspond to points along the axes 27 or 32 of the shafts 26 and 30 respectively. In the first sequence 40 illustrated in FIG. 3, the actual stress measurements of stresses on the axis 36 are measured at points p1 and p2. For point p1 and p2 along the axis 36, a minimum stress (Sₘᵢₙ) and a maximum stress (Sₘₐₓ) may be measured. For illustrative purposes in the calculations below, at point p1, the maximum stress, Sₘₐₓ, may be 50000 and the minimum stress Sₘᵢₙ may be 100000. Similarly, at point p2, the maximum stress may be 50,000, and the minimum stress may be 70,000.

The measures stresses at points p1 and p2 may be separated into an axial stress (sequence 42) and bending stress (sequence 44). The axial stress on the axis 36 may be determined from the averages of the maximum stresses and minimum stresses at points p1 and p2 as indicated by equation (1) below:

$$\frac{{S}_{max} + {S}_{min}}{2} \qquad ( 1 )$$

where:
Sₘₐₓ is the maximum stress at a point on the axis 36, and
Sₘᵢₙ is the minimum stress at a point on the axis 36.

Thus, as shown in sequence 42, at point p1 the axial stress is 80,000+70,000/2 or 75,000. At point p2, the axial stress is 100,000+50,000/2, or 75,000. The axial stress is a combination of axial alignment and axial component of the force on the machine. At no load, the determined axial stress is the axial alignment (or misalignment). This axial misalignment value reflects the axial misalignment (e.g., offset 33A) of a machine as illustrated above in FIG. 2A. Under load, the axial stress may be further deconstructed into an axial alignment (misalignment) component and a force component.

As shown in sequence 44, the bending stress on the axis 36 may be determined from the maximum and minimum stress measurements at p1 and p2. Subtracting the minimum stress (Sₘᵢₙ) from the maximum stress (Sₘₐₓ) at each point indicates the bending stress on the axis 36. Accordingly, the bending stress at each point p1 and p2 may be determined from the maximum stress and minimum stress as indicated by equation (2) below:

$$\frac{{S}_{max} - {S}_{min}}{2} \qquad ( 2 )$$

Thus, as shown in sequence 44, the maximum and minimum bending stresses at point p1 are (50,000−100,000)/2 or −25,000 and (100,000−50,000)/2 or 25,000. Similarly, the maximum and minimum bending stresses at point p2 are (80,000−70,000)/2 or 5,000, and (70,000−80,000)/2 or −5,000.

Angular misalignment (e.g., angle 33C) and offset misalignment (e.g., offset 33B) of a machine may be derived from the bending stresses on the axis 36, as indicated by sequences 46 and 48 respectively. As shown in sequence 46, a simple beam angular misalignment for the points p1 and p2 may be determined by taking half the sum of the bending stresses at two points on the axis 36 (e.g., points p1 and p2). Thus, angular misalignment (e.g., angle 33C) may be determined as indicated by equation (3) below:

$$\frac{{BS}_{p 1} + {BS}_{p 2}}{2} \qquad ( 3 )$$

where:
BSₚ₁ is the bending stress at point p1, and
BSₚ₂ is the bending stress at point p2.

Thus, as shown in sequence 46, for point p1, the angular misalignment may be (−25,000+5,000)/2 or −10,000 and (25,000+−5,000)/2 or 10,000. Similarly, for point p2, the angular alignment may be (−25,000+5,000)/2 or −10,000 and (25,000+−5,000)/2 or 10,000. The angular misalignment values are indicative of the angular misalignment (e.g., angle 33C) of a machine as illustrated in FIG. 2C.

As shown in sequence 48, offset misalignment (e.g., offset 33B) may be determined by halving the difference of the bending stresses at two points on the axis 36 (e.g., points p1 and p2). Thus, offset misalignment (e.g., offset 33B) may be determined as indicated by equation (4) below:

$$\frac{{BS}_{p 1} - {BS}_{p 2}}{2} \qquad ( 4 )$$

Therefore, as shown in sequence 48, for point p1, the offset misalignment stress at point p1 is (−25,000−5,000) or −15,000 and (25,000−−5,000)/2 or 15,000. Similarly, the offset misalignment stress for at point p2 is (5,000−−25,000)/2 or 15,000, and (−5,000−25,000) or −15,000. The offset misalignment values reflect the offset misalignment (e.g., offset 33B) of a machine as illustrated above in FIG. 2B.

It should be appreciated that for a more complex component of a machine, the stresses and misalignments described above may be determined by deconstructing the complex component into simple components. For example, a finite element model may be used to determine the relationship between the bending stress at two locations and the machine alignment.

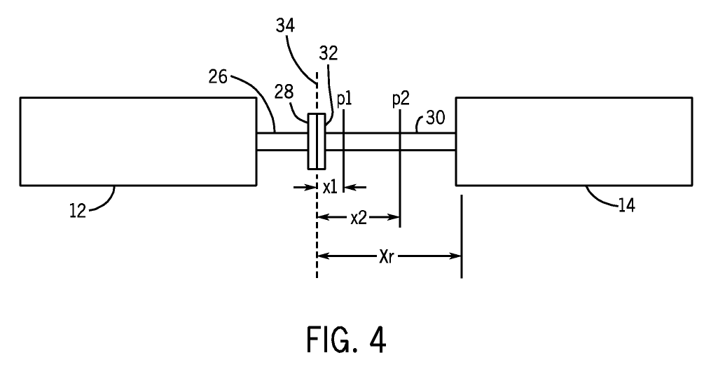

If the physical characteristics (e.g., dimensions) of the machine are known, the displacement and angle of the alignment may be determined from the bending stresses. FIG. 4 illustrates determination of the displacement and angle of an alignment for a uniform beam of a component of a machine in accordance with an embodiment of the present invention. FIG. 4 illustrates the machines 12 and 14 coupled together via shafts 26 and 30 and couplings 28 and 32. As in the embodiments discussed above, points p1 and p2 may correspond to stress measurements on the axis 31 of the shaft 30, as measured by the transducers 18 or other suitable devices. It should be appreciated that similar determinations may be applied to two points on the axis 27 of the shaft 26 of the machine 12, based on stress measurements measured by the transducers 16. The displacement of the machine 14 relative to the centerline (e.g., axes) of the shafts 26 and/or 30, displacement_Xr, may be determined as indicated by equation (5) below:

$$Displacment\_Xr = \frac{( BS 1 - BS 2 )}{6 ( x 1 - x 2 )} {Xr}^{3} + \frac{( BS {2}^{*} x 1 - BS {1}^{*} x 2 )}{2 ( x 1 - x 2 )} {Xr}^{2} \qquad ( 5 )$$

where:
BS1 is the bending stress at p1,
BS2 is the bending stress at p2,
x1 is the distance from the axis 34 to p1 as shown in FIG. 4,
x2 is the distance from the axis 34 to p2 as shown in FIG. 4, and
Xr is the distance from the axis 34 to the body of the machine 14 as shown in FIG. 4.

The angle of the misalignment relative to the relative to the centerline (e.g., axes) of the shafts 26 and/or 30, angle_Xr, may be determined as indicated by equation (6) below:

$$Angle\_Xr = \frac{( BS 1 - BS 2 )}{2 ( x 1 - x 2 )} {Xr}^{2} + \frac{( BS {2}^{*} x 1 - BS {1}^{*} x 2 )}{( x 1 - x 2 )} Xr \qquad ( 6 )$$

where:
BS1 is the bending stress at p1,
BS2 is the bending stress at p2,
x1 is the distance from the axis 34 to p1 as shown in FIG. 4,
x2 is the distance from the axis 34 to p2 as shown in FIG. 4,
Xr is the distance from the axis 34 to the body of the machine 14 as shown in FIG. 4.

Thus, using equations (5) and (6) above, the displacement and angle of the alignment of a machine, relative to relative to the centerline of the shafts 26 and/or 30, may be determined. This determination may be used in those instances in which physical characteristics of the machine, such as the values x1, x2, and Xr described above, are known.

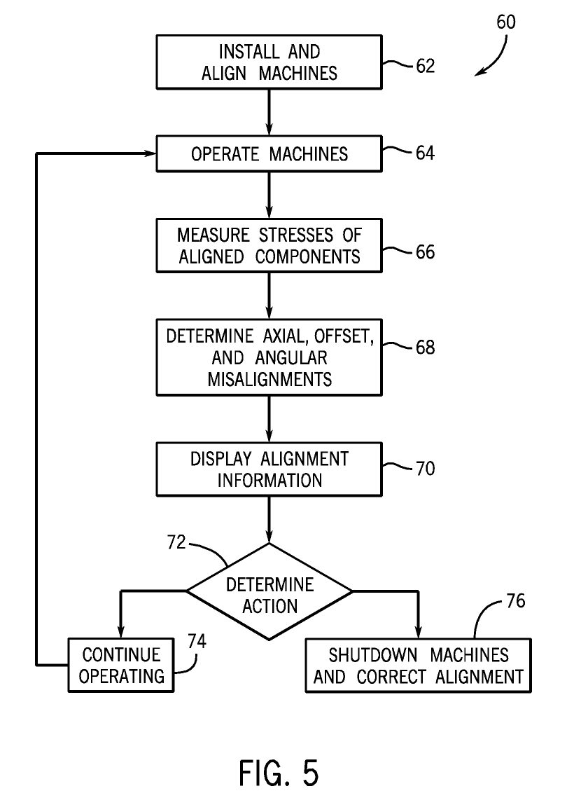

FIG. 5 is an embodiment of a process 60 (e.g., computer-implemented method) for determining the alignment (and misalignment) of a machine using the techniques described above. Any or all steps of the process 60 may be implemented on a computer, such as by code for executing one or more steps of the process 60 stored on a tangible machine-readable medium. A technical effect of the process 60 may include, among others, the determination of various misalignments of a machine based on stress measurements along an axis of the component of a machine.

The machines 12 and 14 may be installed and aligned (block 62). The machines 12 and 14 may be initially aligned using conventional laser or optical systems, or may be aligned using the stress measurements and techniques described above. After the initial alignment the machines 12 and 14 may be operated normally (block 64), relying on the initial alignment to ensure correct operation. As mentioned above, however, the initial alignment may change over the course of operation, as a result of foundation shifts, temperature changes etc.

The stresses on an axis 27 or 31 of the one or more aligned components of the machines 12 and/or 14 may be measured using transducers 16 and 18 or other suitable devices (block 66). The stresses may be measured continuously, e.g., in real-time throughout the operation of the machines 12 and 14. As described above, various misalignments may be determined from the measured stress. For example, axial misalignment, offset misalignment, and/or angular misalignment of the machine 12, machine 14, or both, may be determined from the measures stresses using the equations described above (block 68). After the determination of the misalignment, the alignment (or misalignment) of the machines 12 and/or 14 may be displayed (block 70), such as on the display 24.

Based on the display of the alignment (or misalignment) of the machines 12 and 14, an operator or controller may determine the action to take (decision block 72). If the machines 12 and/or 14 are in alignment, or any misalignments are not severe enough to impact operation of the machines 12 and/or 14, the machines may continue operating (block 74). The process 60 returns to block 64, and the measuring (block 66) and alignment determination (block 68) continue during operation of the machines 12 and 14. If the displayed alignment information indicates that the machines 12 and/or 14 need to be realigned to reduce damage and/or wear to either machine, then the machines 12 and 14 may be shutdown to correct the alignment corrected (block 76), e.g., by realigning the machine 12 and/or 14. In some embodiments, the determination of action may be automated, such that if a threshold misalignment is reached the machines 12 and 14 may be shutdown automatically.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
measuring one or more stresses on a first component of a first machine coupled to a second machine during operation of the first machine, wherein the first machine is coupled to the second machine; and
determining alignment of the first machine based on stress measurements of the first machine.

2. The method of claim 1, comprising measuring one or more stresses on a second component of the second machine.

3. The method of claim 2, comprising determining alignment of the second machine based on the stress measurements of the second component of the second machine.

4. The method of claim 1, wherein determining alignment comprises determining a displacement an angle, or a combination thereof of the alignment relative to an axis defined by a the first component of the first machine.

5. The method of claim 1, comprising wherein determining alignment comprises determining axial misalignment, angular misalignment, offset misalignment, or a combination thereof, of the first machine relative to an axis defined by an axis of the first component.

6. The method of claim 1, comprising displaying stress measurements of the first component of the first machine on a display.

7. The method of claim 1, comprising displaying the alignment on a display.

8. The method of claim 1, comprising determining a maximum stress and a minimum stress at one or more points on an axis of the first component of the first machine.

9. The method of claim 1, comprising determining a bending stress from a maximum stress and minimum stress at a point on an axis of the first component.

10. The method of claim 1, comprising determining an axial stress from an average of a maximum stress and minimum stress at a point on an axis of the first component.

11. The method of claim 1, comprising determining an axial misalignment from a first bending stress at a first point on an axis of the first component and from a second bending stress at a second point on the axis of the first component.

12. The method of claim 1, comprising determining an offset misalignment from a first bending stress at a first point on an axis of the first component and from a second bending stress at a second point on the axis of the first component

13. The method of claim 1, comprising storing a history of the one or more stress measurements, the one or more misalignments, or a combination thereof on a monitor coupled to the first machine.

14. A system, comprising:
a first machine;
a second machine coupled to the first machine;
a first plurality of transducers configured to measure stresses on a first component of the first machine; and
a monitor configured to receive signals from the first plurality of transducers, wherein the monitor comprises logic configured to determine alignment of the first machine based on the stress measurements of the first component of the first machine.

15. The system of claim 14, comprising a display configured to display data received from the monitor.

16. The system of claim 14, comprising a second plurality of transducers configured to measure stresses on a second component of the second machine.

17. The system of claim 16, wherein the monitor is configured to receive signals from the second plurality of transducers.

18. The system of claim 17, wherein the monitor comprises logic configured to determine alignment of the second machine based on the stress measurements of the second component of the second machine.

19. A method, comprising:
measuring a first stress at a first axial location of a component of a first machine;
measuring a second stress at a second axial location of the component of the second machine; and
determining offset, angle, displacement, or a combination thereof from the first stress and the second stress relative to an axis of the component.

20. The method of claim 19, wherein the component comprises a rotor and the axis comprises an axis of the rotor.
